(19) United States
(12) Patent Application Publication
(10) Pub. No.: US 2009/0139993 A1
(43) Pub. Date: Jun. 4, 2009

(54) Plastic spout

(76) Inventor: Laurens Last, Monaco (MC)

Correspondence Address: HOFFMANN & BARON, LLP, 6900 JERICHO TURNPIKE, SYOSSET, NY, 11791, US

(21) Appl. No.: 10/585,641

(22) PCT Filed: Dec. 28, 2004
(86) PCT No.: PCT/NL04/00919

§ 371 Date: Aug. 7, 2006

(30) Foreign Application Priority Data
Jan. 7, 2004 (NL) 1025183

(51) Int. Cl. B65D 6/40; B65D 33/16; B31B 1/84; B65D 6/28

(52) U.S. Cl. 220/601; 383/66; 493/213; 383/906; 220/613; 215/44

(57) ABSTRACT

A plastic medium feed-through part, for example a spout, designed to be sealed by means of a sealing technique between film walls of a bag, comprising a plastic body which forms a channel (4) for dispensing a medium from the bag and/or feeding it to the bag, which body has sealing sides (10, 11) situated opposite each other, each for achieving a sealed connection to an adjoining film wall, which sealing sides are substantially flat and free from ribs. Each sealing side has a rough surface structure. The surface roughness value of the sealing sides preferably lies between 20 and 40 in accordance with VDI Richtlinie 3400. The feed-through part can be provided with an anti-nesting projection (20) on the side intended to be inside the bag or with an element (101) for holding the bag open. Several methods for sealing a feed-through part to a bag are also provided.

A first aspect of the invention relates to a plastic medium feed-through part, for example a spout, designed to be sealed by means of a sealing technique between film walls of a bag, comprising a plastic body which forms a channel for dispensing a medium from the bag and/or feeding it to the bag, which body has sealing sides situated opposite each other, each for achieving a sealed connection to an adjoining film wall.

It is generally known from the prior art to provide each of the sealing sides with a number of sealing ribs extending horizontally, i.e. in the longitudinal direction of the usually elongated sealing sides, in order to achieve a good sealed connection. This is known, for example from U.S. Pat. No. 3,690,524 and U.S. Pat. No. 1,182,144.

In WO 03/031280, on which the preamble of claim 1 is based, it is proposed actually not to provide the sealing sides of the sealing walls with such sealing ribs, but to make them of a flat design, so that the sealed connection between the film walls and the body does not “become concentrated” at the position of sealing ribs as mentioned above, but is uniformly distributed over a relatively large sealing surface. This avoids the problem that, when the sealed connection is subjected to a load, the mechanical stresses become concentrated on those sealing ribs and cause local tearing and delamination of the film material there, which gives rise to quality problems and leakage.

The object of a first aspect of the present invention is to propose an improved version of the plastic medium feed-through part with ribless sealing sides, in particular of the spout according to WO 03/031280.

To that end, the first aspect of the invention provides a plastic medium feed-through part according to the preamble of claim 1, which feed-through part is characterized in that the sealing sides each have a rough surface structure.

The sealing sides are preferably provided with such a rough surface structure over substantially their entire surface.

It is preferable for no sealed connection to be provided in a narrow strip along the free edges of the sealing sides, and said strip is possibly not provided with a rough surface structure.

The rough surface structure of the sealing sides preferably lies in the range between 21 and 42 in accordance with VDI Richtlinie [Standard] 3400, including those limit values.

It is particularly preferable for the surface roughness value of the sealing sides to lie between 24 and 36 in accordance with VDI Richtlinie 3400, including those limit values.

It is advantageous in practice for the surface roughness value of the sealing sides to lie between 27 and 33 in accordance with VDI Richtlinie 3400, including those limit values.

VDI Richtlinie 3400 has the German title: “Electroerosive Bearbeitung. Begriffe, Verfahren, Anwendung” [Electrical Discharge Machining. Definitions, Process, Application]. This Richtlinie 3400 was published by the Verein Deutscher Ingenieure [Association of German Engineers] in June 1975.

The Rₐ (micrometer) and Rₜ (micrometer) are given in the table below for a number of relevant values, Rₐ being the mathematical mean value of the roughness depth, and Rₜ being the maximum roughness depth.

| VDI value | 18 | 21 | 24 | 27 | 30 | 33 | 36 | 39 | 42 |
|---|---|---|---|---|---|---|---|---|---|
| Rₐ | 0.8 | 1.1 | 1.6 | 2.3 | 3.2 | 4.6 | 6.3 | 9 | 13 |
| Rₜ | 4-6 | 5-7.5 | 9-13 | 12-16 | 16-20 | 21-25 | 37-45 | 45-60 | 60-90 |

Plastic medium feed-through parts for sealing into a bag which are provided with sealing sides with such a rough surface structure produce very good adhesion with the film walls of the bag. It also appears that producing the sealed connection between the film walls and the body of the medium feed-through part with the aid of suitable sealing/heat-sealing techniques can proceed at a very high speed without complications. Furthermore, the sealed connections perform very well if they are subjected to mechanical stress, for example in a drop test with a bag filled with liquid.

The first aspect of the invention further relates to a bag provided with such a medium feed-through element.

The first aspect of the invention further relates to a mould for injection moulding the medium feed-through part. The rough surface structure of the sealing sides is in fact preferably achieved by a suitable rough finish of the corresponding mould parts. Such a rough finish can be obtained by, for example, a suitable electrical discharge machining of the material of the mould.

The first aspect of the invention further relates to a method for sealing between the film walls of the bag a medium feed-through part according to claim 11. By this method, the rough surface structure of the sealing sides at least largely disappears, and preferably even fully disappears, during the sealing-in operation, so that a flat and smooth appearance of the sealed area is obtained.

The second aspect of the invention relates to a plastic medium feed-through part, for example a spout, designed to be sealed by means of a sealing/heat-sealing technique between film walls of a bag, comprising a body which forms a channel for dispensing a medium from the bag and/or feeding it to the bag, which body has a transverse wall with a first side and a second side situated opposite said first side, and which wall has an opening in it which forms part of the channel, which body further has sealing walls projecting at an angle from the second side of the transverse wall, which sealing walls each have a sealing side for the purpose of forming a sealed connection to an adjoining film wall, which sealing walls are substantially symmetrical relative to a plane of symmetry substantially perpendicular to the transverse wall and are at the greatest distance from each other in a central area and are connected to each other in end areas situated in the corresponding plane of symmetry, so that the sealing walls bound a space between them.

Such medium feed-through parts are generally known in the prior art in an embodiment as a dispensing spout for dispensing the medium from the bag. In most cases, as in U.S. Pat. No. 3,690,524 and EP 1 182 144, the space between the sealing walls is entirely open and free from other spout parts. During the sealing of such spouts into bags there is a regular occurrence of the problem of “nesting” of the spouts in the equipment supplying them to the heat-sealing equipment, in other words a spout becomes wedged in the open space between the sealing walls of another spout.

FIGS. 3a-3c of WO 03/031280 show a spout in which a tubular part extends from the second side of the transverse wall into the oval space between the sealing walls. Said tubular part is connected by way of flexible bodies to the sealing walls, so that the sealing walls are movable flexibly towards each other. The tubular part between the sealing walls in the case of this embodiment in essence solves the abovementioned problem of the nesting of spouts.

The object of the second aspect of the invention is to achieve an improved medium feed-through part, by means of which the anti-nesting effect according to the prior art explained above is also obtained.

To this end, the second aspect of the invention provides the medium feed-through part according to the preamble of claim 12, which is characterized in that furthermore from the second side of the transverse wall on either side of the opening in the transverse wall an anti-nesting projection projects in each case into the space between the sealing walls, and in that a free passage is present between each of the anti-nesting projections and each adjacent sealing wall, in such a way that said sealing wall is movable flexibly towards the other sealing wall, thereby reducing said free passage.

By this measure, the known tubular part projecting between the sealing walls is, as it were, replaced by individual anti-nesting projections on either side of the opening in the transverse wall, a free passage being present between each of the anti-nesting projections and each adjacent sealing wall, in such a way that said sealing wall is movable flexibly towards the other sealing wall, thereby reducing said free passage.

By this measure, it is ensured that few or no “dead zones” occur in the medium feed-through part for the medium to be dispensed, for example a drink suitable for human consumption.

These anti-nesting projections preferably extend at least to the free edge of the sealing walls.

In a possible embodiment the anti-nesting projections extend beyond the free edge of the sealing walls, so that the anti-nesting projections also acquire the function of preventing the bag from falling shut before the inlet of the channel, and in this way hold the bag open, in particular when the bag is being emptied.

In another variant the anti-nesting projections serve as connecting elements for an element for holding the bag open, for example a tubular element for holding the bag open, which latter element may be fixed on the anti-nesting projections, for example by means of a snap connection.

The free passages preferably run through to the second side of the transverse wall, so that no dead zone at all is present in the space between the sealing walls.

Provision is preferably made for two anti-nesting projections, which are disposed diametrically relative to the opening in the transverse wall, viewed in the direction of the plane of symmetry of the sealing walls. As a result of this arrangement of the anti-nesting projections, the sealing walls can be disposed more closely together along the opening in the transverse wall than was the case in the abovementioned prior art, so that a slimmer unit is produced and plastic material can be saved.

In a preferred embodiment a reinforcement rib is present between each anti-nesting projection, on the one hand, and the adjacent interconnected ends of the sealing walls, on the other, which reinforcement rib extends in the plane of symmetry of the sealing walls. Said reinforcement rib is advantageous in particular for the purpose of sealing the medium feed-through part between the film walls. Because of this rib, the “ends of the medium feed-through part”, i.e. the parts near the interconnected ends of the sealing walls, do not “stick up” or do not shift or bend in the direction from the second side towards the first side of the transverse wall. In the case of known parts this “sticking up” produces, as it were, a curved shape of the transverse wall with a centre part situated lower down and with ends sticking up. This is aesthetically unattractive and has an adverse effect on the controllability of the sealing process.

These ribs are preferably integral with and project from the second side of the transverse wall, so that the transverse wall with the rib has a sort of T-shaped cross section at that point.

In an embodiment which is advantageous in practice each rib is substantially L-shaped with a leg substantially at right angles to the second side of the transverse wall and integral with an anti-nesting projection, and with another leg substantially along the transverse wall.

In an embodiment which is advantageous in practice each anti-nesting projection in cross section parallel to the transverse wall is the shape of a segment of a ring, preferably a segment of a circle.

Each projection with preferably circular segment-shaped cross section preferably directly adjoins the opening in the transverse wall.

A third aspect of the present invention relates to a method according to claim 20 for sealing between film walls of a bag a plastic medium feed-through part, for example a spout, comprising a plastic body which forms a channel for dispensing a medium from the bag and/or feeding it to the bag, which body has sealing sides situated opposite each other, each for achieving a sealed connection to an adjoining film wall, which sealing sides are preferably substantially flat and free from ribs, use being made of a sealing device provided with sealing elements disposed opposite each other and each having a sealing face with which the sealing element is pressed against the film wall, so that the film wall adheres to the medium feed-through part.

In the case of this method provision is made for the sealing faces of the sealing elements to have a rough surface structure, for example with a surface roughness value in accordance with the first aspect of the invention. This method produces a rough exterior of the sealing areas, but does provide considerably improved properties and production advantages compared with the smooth sealing faces of the sealing elements which have been in common use until now.

A fourth aspect of the invention relates to a method according to claim 21 for sealing between film walls of a bag a plastic medium feed-through part, for example a spout, comprising a plastic body which forms a channel for dispensing a medium from the bag and/or feeding it to the bag, which body has a transverse wall with an outermost edge and sealing sides situated opposite each other, which sealing sides connect to the outermost edge of the transverse wall, each sealing side for achieving a sealed connection to an adjoining film wall, which sealing sides are preferably substantially flat and free from ribs, use being made of a sealing device provided with sealing elements disposed opposite each other and each having a sealing face with which the sealing element is pressed against the film wall, so that the film wall adheres to the medium feed-through part.

In the case of this method according to the fourth aspect the sealing elements each have, on the side facing the sealing element situated opposite, an overhanging rib which rests on top of the outermost edge of the transverse wall during the sealing, so that melting plastic material is prevented from running out between the film wall and the feed-through part in the region of the outermost edge.

A fifth aspect of the invention relates to a method according to claim 22 for sealing between film walls of a bag a plastic medium feed-through part, for example a spout, comprising a plastic body which forms a channel for dispensing a medium from the bag and/or feeding it to the bag, which body has a transverse wall with an outermost edge and sealing sides situated opposite each other, which sealing sides connect to the outermost edge of the transverse wall, each sealing side serving to achieve a sealed connection to an adjoining film wall, which sealing sides are preferably substantially flat and free from ribs, use being made of a sealing device provided with sealing elements disposed opposite each other and each having a sealing face with which the sealing element is pressed against the film wall, so that the film wall adheres to the medium feed-through part.

The fifth aspect of the invention provides for the sealing faces to have one or more recesses, in such a way that at the position of a recess little—or possibly no—excessive pressure is exerted upon the film wall and the medium feed-through part.

A sixth aspect of the invention relates to a plastic medium feed-through part according to claim 25, for example a spout, designed to be sealed by means of a sealing technique between film walls of a bag, comprising a plastic body which forms a channel for dispensing a medium from the bag and/or feeding it to the bag, which body has sealing sides situated opposite each other, each for achieving a sealed connection to an adjoining film wall. In this case the medium feed-through part is provided with an element for holding the bag open, which element projects below the sealing sides, preferably substantially in line with the channel.

In combination with the second aspect of the invention, the sixth aspect of the invention can be achieved by the element for holding the bag open being formed by one or more of the anti-nesting projections.

In a possible embodiment the element for holding the bag open is tubular, so that its interior is in communication with the channel. The tubular element may be provided with openings in the tube wall, for example elongated slits, holes, etc.

A seventh aspect of the invention relates to a medium feed-through part, for example a spout, designed to be sealed by means of a sealing technique between film walls of a bag, comprising a body which forms a channel for dispensing a medium from the bag and/or feeding it to the bag, which body has a transverse wall with a first side and a second side situated opposite said first side, which wall has in it an opening which forms part of the channel, which body further has sealing walls projecting at an angle from the second side of the transverse wall, which sealing walls each have a sealing side for forming a sealed connection to an adjoining film wall, which sealing walls are substantially symmetrical relative to a plane of symmetry substantially perpendicular to the transverse wall and are at the greatest distance from one another in a central area and are connected to one another in end areas situated in the corresponding plane of symmetry, so that the sealing walls bound a space between them, the transverse wall having a central part and also in each case an outermost end on either side of said central part, each end being near the merging end areas of the sealing walls. It is ensured here that the first ends of the transverse wall, viewed in the direction from the free edge of the sealing walls towards the transverse wall, lie lower down than the central part of the transverse wall.

The “drooping” shape of the transverse wall ensures that during the sealing in of the medium feed-through part said outermost ends are prevented from sticking up and, as it were, projecting beyond the film walls, as can be seen in the case of the prior art.

It will be clear to the person skilled in the art that the aspects of the invention mentioned here can be applied either separately or in combination.

The various aspects of the invention will be explained in greater detail below with reference to the drawing, in which:

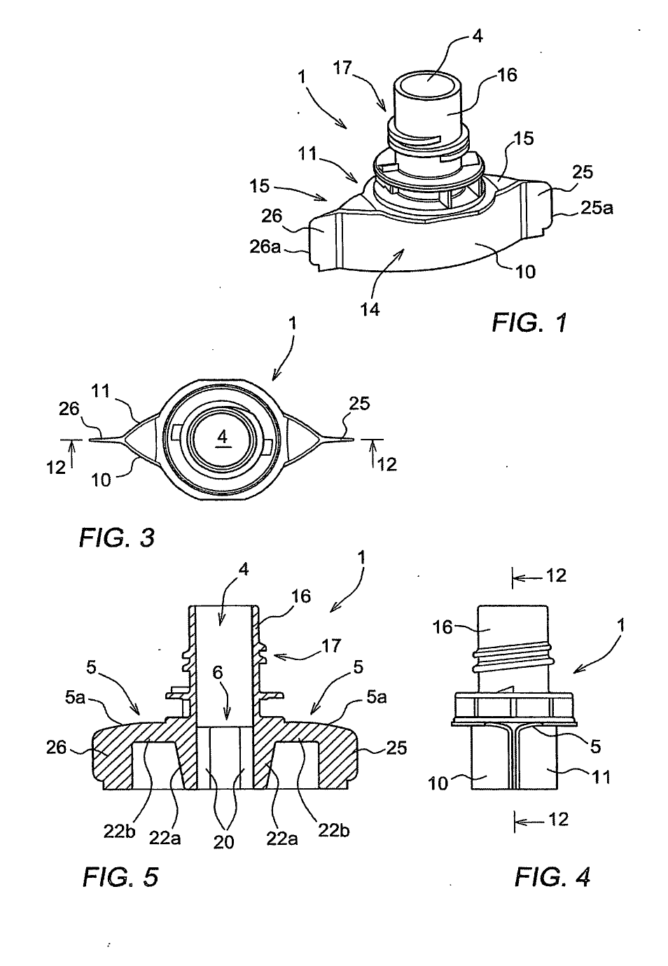

FIG. 1 shows in perspective an exemplary embodiment of a spout according to the invention;

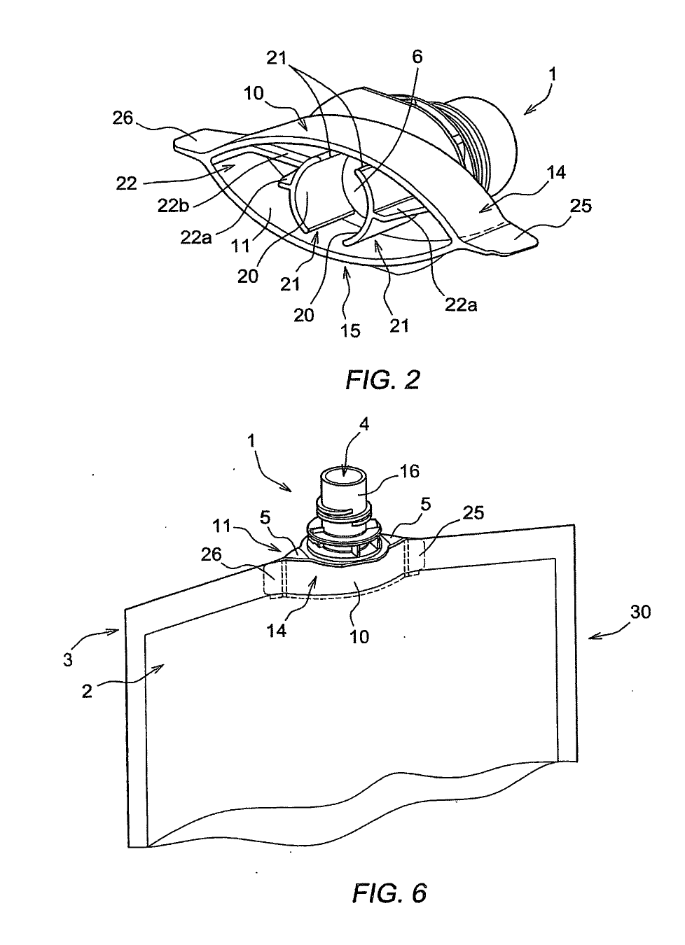

FIG. 2 shows the spout of FIG. 1 in a different view in perspective;

FIG. 3 shows the spout of FIG. 1 in top view;

FIG. 4 shows the spout of FIG. 1 in side view;

FIG. 5 shows the spout of FIG. 1 in cross section;

FIG. 6 shows a bag provided with the spout according to FIG. 1;

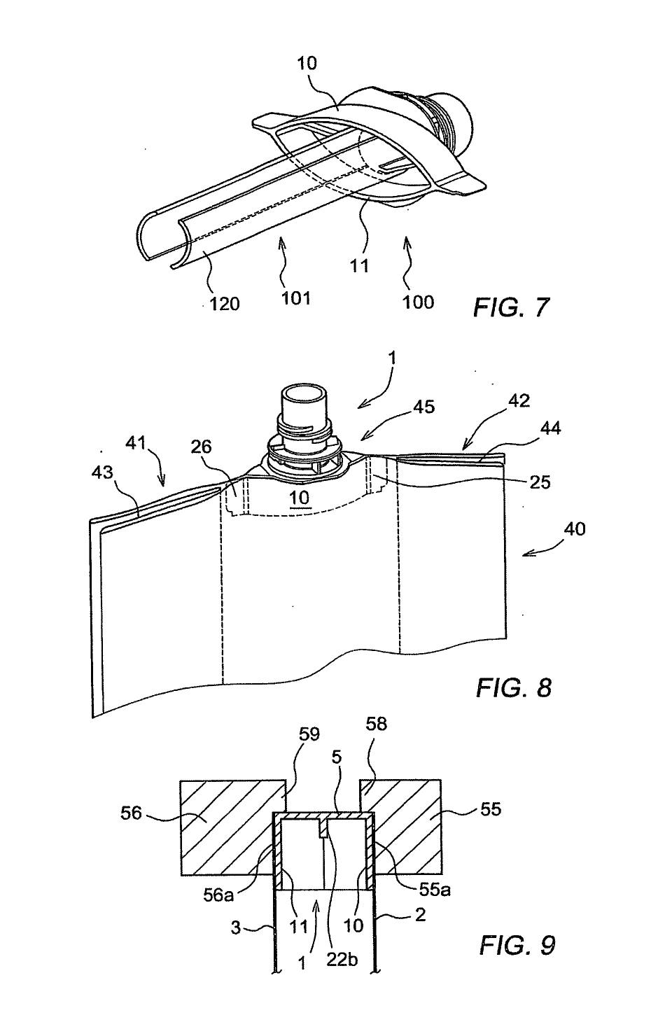

FIG. 7 shows a variant of the spout of FIGS. 1-5;

FIG. 8 shows the spout of FIGS. 1-5 in a side-gusset bag; and

FIG. 9 shows in cross section the spout of FIGS. 1-5 during its sealing in between film walls with sealing elements according to the invention.

A number of aspects of the invention will be explained in greater detail below with reference to the medium feed-through part embodied as a spout by way of example.

The spout 1 has a monolithic plastic body, which is obtained by injection moulding in a suitable mould.

The spout 1 is designed to be sealed by means of a heat-sealing/sealing technique between film walls 2, 3 of a bag 30 (see FIG. 6), here in the region of the side edges of the film walls. For example, a sealing technique is used in the case of which on either side of the spout heated sealing elements of a sealing apparatus are pressed from the outside against the film walls and in this way bring about a fusion-welded connection between the film walls and the spout 1. Other techniques, for example with ultra sound, are also conceivable.

The body of the spout 1 forms a channel 4 for dispensing a medium, such as a liquid or powder or the like, for example a drink suitable for human consumption, from the bag 30 and/or feeding it to the bag.

The body of the spout is shown in detail in the figures and has a transverse wall 5 with an opening 6 in it which forms part of the channel 4, and also with sealing walls 10, 11 which project at an angle from the transverse wall and are substantially symmetrical relative to a plane of symmetry 12 substantially perpendicular to the transverse wall 5.

The sealing walls 10, 11 are at the greatest distance from each other in a central area and are connected to each other in end areas situated in the corresponding plane of symmetry (at 13). The sealing walls 10, 11 are of a thin construction in this example.

Each sealing wall 10, 11 has an outside which forms a sealing side 14, 15, each sealing side for achieving a sealed connection to an adjoining film wall.

The body of the spout 1 further has a tubular element 16, which forms part of the channel 4 and extends from the side of the transverse wall 5 facing away from the sealing walls 10, 11. In this case the inner channel in the tubular element 16 lies in line with the opening in the transverse wall 5.

The tubular element 16 is provided here with screw thread 17 for a screw cap. In the sealed state the tubular element 16 projects beyond the periphery of the film walls of the bag 30.

As can be seen in the figures, the sealing sides 14, 15 are elongated faces, which are substantially flat and are free from outwardly projecting sealing ribs.

The sealing sides 14, 15 each have a rough surface structure over substantially their entire surface. Said rough surface structure gives rise to a sealed connection of high quality, in terms of density, load-bearing capacity and appearance, between the film walls and sealing walls 10, 11.

The surface roughness value of the sealing sides 14, 15 preferably lies between 20 and 40 in accordance with VDI Richtlinie 3400.

It is particularly advantageous for the surface roughness value of the sealing sides to lie between 25 and 35, and in practice the optimum results are achieved with a value between 28 and 32 in accordance with VDI 3400.

Such roughened sealing sides 14, 15 can be obtained during production of the spout 1 by using a mould for injection moulding the spout, which mould has a mould cavity with wall parts which define the sealing sides of the body and in the case of which the wall parts concerned are provided with a rough surface structure, for example obtained by a suitable electrical discharge machining operation.

It can further be seen that at each of the merging end areas of the sealing walls 10, 11 the spout 1 is provided with an outwardly projecting flap 25, 26 lying in the plane of symmetry, which flap also ultimately lies between the film walls 2, 3. The flaps 25, 26 taper outwards to a sharp side edge 25a, 26a.

It can be seen in particular in FIGS. 2 and 5 that on either side of the opening in the transverse wall 5 in each case the body of the spout 1 has an anti-nesting projection 20, which projects from said side of the transverse wall 5 into the space between the sealing walls 10, 11. It can also be seen that a free passage 21 is present between each of the anti-nesting projections 20 and each adjacent sealing wall 10, 11, in such a way that said sealing wall 10, 11 is movable flexibly towards the other sealing wall, thereby reducing said free passage.

It can also be seen that in the area between each anti-nesting projection 20 and the adjacent end areas of the sealing walls 10, 11 connecting to each other a reinforcement rib 22 lying substantially in the plane of symmetry is present, which reinforcement rib is integral with the transverse wall 5.

The reinforcement rib 22 shown is substantially L-shaped with a leg 22a substantially at right angles to the transverse wall 5 and integral with an anti-nesting projection 20, and with another leg 22b substantially along the second side of the transverse wall 5 and integral with said transverse wall 5.

Each anti-nesting projection 20 here forms in cross section parallel to the transverse wall 5 a segment of a circular ring. Furthermore, each anti-nesting projection 20 directly adjoins the opening in the transverse wall 5, so that the anti-nesting projections 20 here lie in line with the wall of the tubular element 16.

The anti-nesting projections 20 here continue to the plane of the free edges of the sealing walls 10, 11.

The anti-nesting projections 20 prevent a spout 1 with its tubular element 16 from being able to nest in another spout 1, which prevents problems with the feeding of the spouts to the sealing equipment. Medium can flow out of the bag through the passages 21 to the channel 4, so that “dead zones” are prevented.

The ribs 22 reinforce the spout 1 in such a way that during the sealing operation the areas near the ends of the sealing walls connecting to each other deform upwards, say from the edge of the bag outwards. It can be seen in FIG. 5 in particular that the outermost ends of the transverse wall 5, viewed in the direction from the free edge of sealing walls 10, 11 towards the transverse wall 5, lie lower down than the central part of the transverse wall 5. This means that the transverse wall 5 has between the central part and each outermost end a shoulder part 5a sloping off towards the outermost end, so that at those points of the tubular element the transverse wall 5 slopes off in a direction away from there. This sloping line continues at the flaps 25, 26.

FIG. 7 shows a spout 100 as a variant of the spout 1. The spout 100 is provided with an element 101 for holding the bag open, which element projects beyond the sealing walls 10, 11, preferably substantially in line with the channel.

The element 101 is in fact obtained here by extending the anti-nesting projections 20 to projections 120. Holes may also be provided in those projections. In this way a more or less tubular element 101 is obtained, so that the inside of said element is in communication with the channel 4.

The element 101 prevents the bag from falling shut while it is being emptied.

In FIG. 8 the spout 1 is placed in a side-gusset bag 40 with on each side 41, 42 a part of each film wall 43, 44 folded inwards, so that a fourfold film wall thickness is present there, and a central part 45 is formed by two unconnected film walls. The spout 1 is placed in the central part 45. In order to obtain an optimum sealed connection, provision is made for the opposite sealing faces of the sealing elements (not shown) to be designed with recessing in the region of the fourfold film wall thickness (at 41 and 42), in order to compensate for the lower film wall thickness relative to the central part 45.

For an optimum sealed connection, the sealing faces of the sealing elements are also provided with a recess at the level of each flap 25, 26 of the spout 1. This means that excessive pressure on the plastic material of the flaps 25, 26 during the sealing is avoided, so that melting plastic material does not run in an undesirable way.

The sealing faces of the sealing elements in the area which ultimately presses against the sealing walls 10, 11 can also be provided with suitable local recesses, preferably shallow recesses.

FIG. 9 illustrates diagrammatically in a cross-sectional view the method for sealing a plastic medium feed-through part, in this example the spout 1 of FIGS. 1-5, between film walls 2, 3 of a bag 30. In FIG. 9 the transverse wall 5 can be seen with an outermost edge. Furthermore, the sealing walls 10, 11 situated opposite each other can be seen, which sealing walls connect to the outermost edge of the transverse wall 5.

In the method use is made of a sealing device provided with sealing elements 55, 56, which are disposed opposite each other and each have a sealing face 55a, 56a by means of which the sealing element is pressed against the film wall 2, 3, so that the film wall adheres to the spout 1.

The sealing elements can operate by any suitable technique, for example by heating, or they may be driven ultrasonically.

The sealing elements 55, 56 each have on the side facing the sealing element situated opposite an overhanging rib 58, 59 which during sealing rests on top of the outermost edge area of the transverse wall 5, so that in the region of that outermost edge melting plastic material is prevented from running out between the film wall 2, 3 and the spout 1. Melting material may possibly still flow towards the free edge of the sealing wall 10, 11 and run out at that side, but that is considerably less of a problem.

1. A spout designed to be sealed by means of a sealing technique between film walls of a bag, comprising:
a plastic body which forms a channel therein that allows for at least one of dispensing a medium from the bag and feeding a medium to the bag,
wherein the body of the spout has sealing sides situated opposite each other, each sealing side having a sealing surface which is substantially flat and free from ribs and is adapted for achieving a sealed connection to an adjoining film wall of said bag,
wherein each sealing surface has a rough surface structure.

2. A spout according to claim 1, wherein the sealing side has a surface roughness value which lies between 20 and 40 in accordance with VDI Richtlinie 3400.

3. A spout according to claim 1, wherein the sealing surface has a surface roughness value which lies between 23 and 35 in accordance with VDI Richtlinie 3400.

4. A spout according to claim 1, wherein the sealing surface has a surface roughness value lies between 26 and 34 in accordance with VDI Richtlinie 3400.

5. A spout according to claim 1, wherein the body has a transverse wall with an opening therein which opening forms part of the channel, and wherein said body further includes sealing walls which project at an angle from the transverse wall and are substantially symmetrical relative to a plane of symmetry substantially perpendicular to the transverse wall and wherein said sealing walls each have an outside portion forming said sealing surface of the spout.

6. A spout according to claim 5, wherein said sealing walls are at the greatest distance from each other in a central area and are connected to each other in end areas situated in the corresponding plane of symmetry.

7. A spout according to claim 1, wherein the body has a tubular element which forms part of the channel of the spout.

8. A spout according to claim 1, wherein the body has a transverse wall with an opening therein which opening forms part of said channel, and in which said body further includes sealing walls which project at an angle from said transverse wall and are substantially symmetrical relative to a plane of symmetry substantially perpendicular to said transverse wall, and wherein said sealing walls each have an outside forming said sealing side surface of the spout, and in which the body has a tubular element which forms part of the channel of the spout, said the tubular element extending from a side of the transverse wall facing away from the sealing walls.

9. A bag having film walls and provided with a spout according claim 1 which is sealed between said film walls of the bag by a sealing technique.

10. A mould for injection moulding a spout according to claim 1, wherein the mould has a mould cavity with wall parts which define the sealing sides of the body of the spout and wherein said wall parts are provided with a rough surface structure.

11. Method for sealing a plastic spout according to claim 1 between film walls of a bag, in which use is made of a sealing device provided with sealing elements disposed opposite each other and each having a sealing face by means of which the sealing bar is pressed against the film wall, so that the film wall adheres to the spout medium feed-through part, wherein the sealing faces are substantially flat, so that the rough surface structure of the sealing walls at least partially disappears during the sealing, and a flat unit is preferably obtained.

12-19. (canceled)

20. A method for sealing between film walls of a bag and a spout, comprising:
providing a plastic body which forms a channel for dispensing a medium from the bag and/or feeding it to the bag, which body has sealing sides situated opposite each other, each for achieving a sealed connection to an adjoining film wall, which sealing sides are substantially flat and free from ribs,
providing a sealing device having sealing elements disposed opposite each other and each having a sealing face, wherein the sealing faces of the sealing elements have a rough or structured surface structure, and
pressing the sealing elements is pressed against the film wall, so that the film wall adheres to the spout.

21. A method for sealing between film walls of a bag and a spout, comprising:
providing a plastic body which forms a channel for dispensing a medium from the bag and/or feeding it to the bag, which body has a transverse wall with an outermost edge and sealing sides situated opposite each other which connect to the outermost edge of the transverse wall, each sealing side for achieving a sealed connection to an adjoining film wall, which sealing sides are preferably substantially flat and free from ribs,
providing a sealing device having sealing elements disposed opposite each other and each having a sealing face,
pressing the sealing elements is against the film wall, so that the film wall adheres to the spout,
wherein the sealing elements each have on the side facing the sealing element situated opposite an overhanging rib, which rib rests on top of the outermost edge area of the transverse wall during the sealing, so that melting plastic material is prevented from running out between the film wall and the spout in the region of that outermost edge.

22. A method for sealing between film walls of a bag and a spout, comprising:
providing a plastic body which forms a channel for dispensing a medium from the bag and/or feeding it to the bag, which body has a transverse wall with an outermost edge and sealing sides situated opposite each other which connect to the outermost edge of the transverse wall, each sealing side serving to achieve a sealed connection to an adjoining film wall, which sealing sides are preferably substantially flat and free from ribs,
providing a sealing device having sealing elements disposed opposite each other and each having a sealing face,
pressing the sealing elements against the film wall, so that the film wall adheres to the spout,
wherein the sealing faces are provided with one or more recesses, in such a way that at the position of a recess little—or possibly no—excessive or unequal pressure is exerted by a sealing element upon the film wall and the spout.

23. A method according to claim 22, in which at each of the merging end areas of the sealing sides the spout is provided with an outwardly projecting flap, which flap also ultimately lies between the film walls, and in which the sealing faces of the sealing elements are provided with a recess at the level of each flap.

24. A method according to claim 23, in which the bag is a side-gusset bag having on each side a part of each film wall folded inwards, so that a fourfold film wall thickness is present there, and a central part formed by two film walls, the spout being placed in the central part, and the sealing faces of the sealing elements situated opposite each other being of a recessed design in the area of the fourfold wall thickness, in order to compensate for the film wall thickness relative to the central part.

25-29. (canceled)

30. A spout according to claim 1, wherein each sealing surface has a rough surface structure over the entire sealing side surface.

31. A spout according to claim 1, wherein the body has a tubular element which forms part of the channel of the spout, and wherein the tubular element is provide with a screw thread for a screw cap.
